(19) United States
(12) Patent Application Publication
(10) Pub. No.: US 2011/0078104 A1
(43) Pub. Date: Mar. 31, 2011

(54) METHOD AND APPARATUS OF CONSTRAINT VERIFICATION IN DISTRIBUTED INFORMATION SPACES

(75) Inventors: Jukka HONKOLA, Espoo (FI); Vesa-Veikko LUUKKALA, Espoo (FI)

(73) Assignee: Nokia Corporation, Espoo (FI)

(21) Appl. No.: 12/569,724

(22) Filed: Sep. 29, 2009

(51) Int. Cl. G06N 5/02

(52) U.S. Cl. 706/47

(57) ABSTRACT

An approach is provided for verification of information consistency in distributed information spaces using binary decision diagrams. A binary decision diagram construction platform constructs an augmented binary decision diagram for the information based on the logical rules defined in an ontology and transmit the diagram to the server managing information sharing. The server uses the type constraints and the cardinality constrains encoded in the diagram to verify consistency of information in information spaces. Therefore, even if the managing server has no access to the ontology, information consistency constraints can be transmitted to the server over the communication network in the form of binary decision diagrams and the information consistency can be verified locally without having to transmit the whole information space over the network to be verified in a remote location.

### BACKGROUND

Mobile devices with various methods of connectivity are now for many people becoming the primary gateway to the internet and also a major storage point for personal information. This is in addition to the normal range of personal computers and furthermore sensor devices plus internet based providers. Combining these devices together and lately the applications and the information stored by those applications is a major challenge of interoperability. This is achieved through numerous, individual and personal information spaces in which persons, groups of persons, etc. can place, share, interact and manipulate webs of information, often referred to as smart spaces or information spaces. These information spaces are extensions of the ‘Giant Global Graph’ in which one can apply semantics and reasoning at a local level with their own locally agreed semantics without necessarily conforming to an unobtainable, global whole. For these numerous and distributed bodies of information to interoperate properly various data integrity issues such as data inconsistency need to be addressed.

Each information space entity can be considered as an aggregated information set from different sources based on their semantics. This multi-sourcing offers considerable flexibility by enabling the same piece of information to come from different sources. Furthermore, in an information space, information requested by a user may be distributed over several information sets managed by different entities, and therefore in order to deduce an accurate answer to a request, there is the need for extracting or combining the information from different sources into a new information space. However, inconsistencies may exist in information retrieved from different sources which may lead to erroneous content and incorrect query results from the combined information.

### SOME EXAMPLE EMBODIMENTS

Therefore, there is a need for an approach for detection of inconsistencies with respect to a given ontology.

According to one embodiment, a method comprises receiving a request to determine consistency of information stored in an information space. The method also comprises retrieving one or more logical rule wherein, each of the rules identifies a consistency constraint on the information. Additionally, the method comprises encoding the one or more logical rules into one or more binary decision diagrams each having a constrained set size. The method further comprises causing, at least in part, conveyance of the one or more encoded binary decision diagrams in response to the request for determining the consistency.

According to another embodiment, an apparatus comprising at least one processor, and at least one memory including computer program code, the at least one memory and the computer program code configured to, with the at least one processor, cause, at least in part, the apparatus to receive a request to determine consistency of information stored in an information space. The apparatus is also caused, at least in part, to retrieve one or more logical rule wherein, each of the rules identifies a consistency constraint on the information. The apparatus is also caused, at least in part, to encode the one or more logical rules into one or more binary decision diagrams each having a constrained set size. The apparatus is further caused, at least in part, to convey of the one or more encoded binary decision diagrams in response to the request for determining the consistency

According to another embodiment, a computer-readable storage medium carrying one or more sequences of one or more instructions which, when executed by one or more processors, cause, at least in part, an apparatus to receive a request to determine consistency of information stored in an information space. The apparatus is also caused, at least in part, to retrieve one or more logical rule wherein, each of the rules identifies a consistency constraint on the information. The apparatus is also caused, at least in part, to encode the one or more logical rules into one or more binary decision diagrams each having a constrained set size. The apparatus is further caused, at least in part, to convey of the one or more encoded binary decision diagrams in response to the request for determining the consistency

According to another embodiment, an apparatus comprises means for receiving a request to determine consistency of information stored in an information space. The apparatus also comprises means for retrieving one or more logical rule wherein, each of the rules identifies a consistency constraint on the information. The apparatus also comprises means for encoding the one or more logical rules into one or more binary decision diagrams each having a constrained set size. The apparatus further comprises means for causing, at least in part, conveyance of the one or more encoded binary decision diagrams in response to the request for determining the consistency.

According to another embodiment, a method comprises generating a request to determine consistency of information stored in an information space. The method also comprises causing, at least in part, transmission of the request to a binary decision diagram construction platform, and receiving a response specifying one or more encoded binary decision diagrams each having a constrained set size, from the platform, wherein the one or more encoded binary decision diagrams are encoded with one or more logical rules. Each of the rules identifies a consistency constraint on the information. The method further comprises verifying consistency of the information using the logical rules of the one or more encoded binary decision diagrams.

According to another embodiment, an apparatus comprising at least one processor, and at least one memory including computer program code, the at least one memory and the computer program code configured to, with the at least one processor, cause, at least in part, the apparatus to generate a request to determine consistency of information stored in an information space. The apparatus is also caused, at least in part, transmission of the request to a binary decision diagram construction platform, and receiving a response specifying one or more encoded binary decision diagrams each having a constrained set size, from the platform, wherein the one or more encoded binary decision diagrams are encoded with one or more logical rules. Each of the rules identifies a consistency constraint on the information. The apparatus is further caused, at least in part, to verify consistency of the information using the logical rules of the one or more encoded binary decision diagrams.

According to another embodiment, a computer-readable storage medium carrying one or more sequences of one or more instructions which, when executed by one or more processors, cause, at least in part, an apparatus to generate a request to determine consistency of information stored in an information space. The apparatus is also caused, at least in part, transmission of the request to a binary decision diagram construction platform, and receiving a response specifying one or more encoded binary decision diagrams each having a constrained set size, from the platform, wherein the one or more encoded binary decision diagrams are encoded with one or more logical rules. Each of the rules identifies a consistency constraint on the information. The apparatus is further caused, at least in part, to verify consistency of the information using the logical rules of the one or more encoded binary decision diagrams.

According to yet another embodiment, an apparatus comprises means for generating a request to determine consistency of information stored in an information space. The apparatus also comprises means for causing, at least in part, transmission of the request to a binary decision diagram construction platform, and receiving a response specifying one or more encoded binary decision diagrams each having a constrained set size, from the platform, wherein the one or more encoded binary decision diagrams are encoded with one or more logical rules. Each of the rules identifies a consistency constraint on the information. The apparatus further comprises means for verifying consistency of the information using the logical rules of the one or more encoded binary decision diagrams.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of verifying information consistency in distributed information spaces, according to one embodiment;

FIG. 2 is a flowchart of a process for constructing binary decision diagrams, according to one embodiment;

FIG. 3 is a flowchart of a general process for verifying information consistency in information spaces, according to one embodiment;

FIG. 4 is a flowchart of an example application for information consistency verification of information spaces, according to one embodiment;

FIG. 5 is a flowchart of the detailed process for information consistency verification of information spaces, according to one embodiment;

FIG. 6A is a diagram of a binary decision diagram, according to one embodiment;

FIG. 6B is a diagram of a reduced ordered binary decision diagram, according to one embodiment;

FIG. 7 is a flowchart of a process for constructing an augmented binary decision diagram, according to one embodiment;

FIG. 8 is a diagram of an implementation for an information space structure, according to one embodiment;

FIG. 9 is a diagram of hardware that can be used to implement an embodiment of the invention;

FIG. 10 is a diagram of a chip set that can be used to implement an embodiment of the invention; and

FIG. 11 is a diagram of a mobile terminal (e.g., handset) that can be used to implement an embodiment of the invention.

### DESCRIPTION OF SOME EMBODIMENTS

Examples of a method, apparatus, and computer program for verifying information consistency in distributed information spaces are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

As used herein, the term “decision diagram” refers to a compact graphical and/or mathematical representation of a decision situation, sets, or relations. A decision diagram, for example, may be a binary decision diagram (BDD) or a reduced ordered binary decision diagram (ROBDD). A BDD is “ordered” if different variables appear in the same order on all paths from the root. A BDD is “reduced” if any isomorphic subgraphs of its graph are merged and any nodes whose two child nodes are isomorphic are eliminated. Isomorphic subgraphs of the same decision diagram have similar appearance but originate from different sources. A ROBDD is a group of Boolean variables in a specific order and a directed acyclic graph over the variables. A directed acyclic graph (DAG) contains no cycles. This means that if there is a route from node A to node B then there is no way back.

A decision diagram may be used to organize any data, including metadata identifying information constraints, into a tree-type data structure that permits constraint retrieval by traversing various branches of the structure. Although various embodiments are described with respect to information constraints, it is contemplated that the approach described herein may be used with other data that can be organized into a tree-type data structure. The term “AUGBDD” refers to an augmented ROBDD which is augmented information including the ROBDD and at least one of a header with a construction history of the ROBDD, relationships between data tables, types and cardinality information, which places constraints on the types and number of class instances a property may connect (with respect to a given ontology, etc.).

Furthermore, as used herein, the term ontology refers to collections of rules, regulations and constraints that are used for explicating semantic knowledge about information. The term “ontology” has been used in many ways and across different communities. For example an ontology can be used to explicate concepts of a shared vocabulary and their properties. Terms from a natural language can be assumed to be a shared vocabulary relying on a common understanding of certain concepts with little variety. This common understanding relies on the idea of how the world is organized. This idea is often called a “conceptualization” of the world. Such conceptualizations provide a terminology that can be used for communication.

The main problem with the use of a shared terminology according to a specific conceptualization of the world is that much information remains implicit. Ontologies have set out to overcome the problem of implicit and hidden knowledge by making the conceptualization of a domain (e.g., computer science) explicit. Therefore, ontology is defined as: “An explicit specification of a conceptualization.” For example, a class PERSON can be defined as having a Name and potentially several other associated properties such as an identification number (ID). A class may also be a subclass of another class. For example, class PERSON is a subclass of class HUMAN. A class can be instantiated to a graph so that it is represented by a node and possible properties are arcs from the class node to other nodes. These property arcs can be thought of as being properties of the node object and have values that are the nodes targeted by the property arcs. For example if object A is an instance of class PERSON, it may have a NAME arc to A's name (e.g., Jane) and an arc for ID to A's identification number (e.g., 1234). A class instance typically also has an arc that connects it to its class type (e.g., from node A to node PERSON). An ontology O has the notion of a property P, which has a range R and a domain D such that,

$$O \text{:} D {\to }^{P} R ,$$

where R and D are both classes. The ontology of the example states that class PERSON can be related to a class of alphabet strings N by NAME property

$$O \text{:} PERSON {\to }^{NAME} N .$$

Class PERSON can also be connected to the class of Integer numbers by ID property:

$$O \text{:} PERSON {\to }^{ID} INTEGER .$$

For the example of class PERSON, it is possible to add an arbitrary property which may or may not be defined in the ontology. For example, a non-ontology supported property AGE can be added to the class PERSON. Also, it is possible to add second (third or fourth) ID properties since conceptual description specifications, such as the Resource Description Framework (RDF) usually do not control cardinality constraints. It can be defined in the ontology that a PERSON may have only one associated ID property. In this case, addition of more than one IDs violates the ontology and the information will be inconsistent with respect to the ontology. Another issue may arise when ontology information is not locally available, while the information is needed for checking information consistency.

Recent technologies such as technologies used for information sharing among mobile devices are developed on the basis of distributed information spaces. However, information stored on storage devices has no specific meaning attached to it. The meaning of information that makes the information valuable for use is referred to as “semantics”. For example, the following information can be stored in a patient's record at the hospital: “Patient A's systolic blood pressure is 150 mmHg”. This piece of information has no value unless the following semantic is attached to it: “Normal range for systolic blood pressure is between 90 mmHg and 119 mmHg.” Attachment of this semantic to the information about patient A may activate an alarm that patient A's systolic blood pressure is dangerously high.

Therefore, there is a need for an approach for verifying information consistency in distributed information systems (e.g., information spaces) with respect to a given ontology. In such a system often referred to as a distributed, ontology based information sharing management system (e.g., M3) the information bases are distributed nodes that communicate by exchanging information graphs (e.g., RDF graphs) via a blackboard or shared memory.

RDF graphs consist of a set of unique triples of form subject, predicate, object, which allow expressing graphs. Simplest RDF graph is a single triple and the store may contain several unconnected graphs. RDF is a family of World Wide Web Consortium (W3C) specifications originally designed as a metadata data model. RDF has come to be used as a general method for conceptual description or modeling of information that is implemented in web resources; using a variety of syntax formats. The underlying structure of any expression in RDF is a collection of triples, each consisting of three disjoint sets of nodes including a subject, a predicate and an object. A subject is an RDF Uniform Resource Identifier (URI) reference (U) or a Blank Node (B), a predicate is an RDF URI reference (U), and an object is an RDF URI reference (U), a literal (L) or a Blank Node (B). A set of such triples is called an RDF graph. Table 1 shows sample RDF triples.

TABLE 1

| Subject | Predicate | Object |
|---|---|---|
| uri://....../rule#CD- | rdf:type, | uri://............/Rule |
| introduction, | | |
| uri://....../rule#CD- | uri://....../rule#assumption, | “c” |
| introduction, | | |

In one embodiment, ontology violation detection is used to enforce consistency of RDF store. This consistency is one of the requirements for information interoperability.

Although various embodiments are described with respect to the ontology, it is contemplated that the approach described herein may be used with other specifications and methods for explicating semantic knowledge about information.

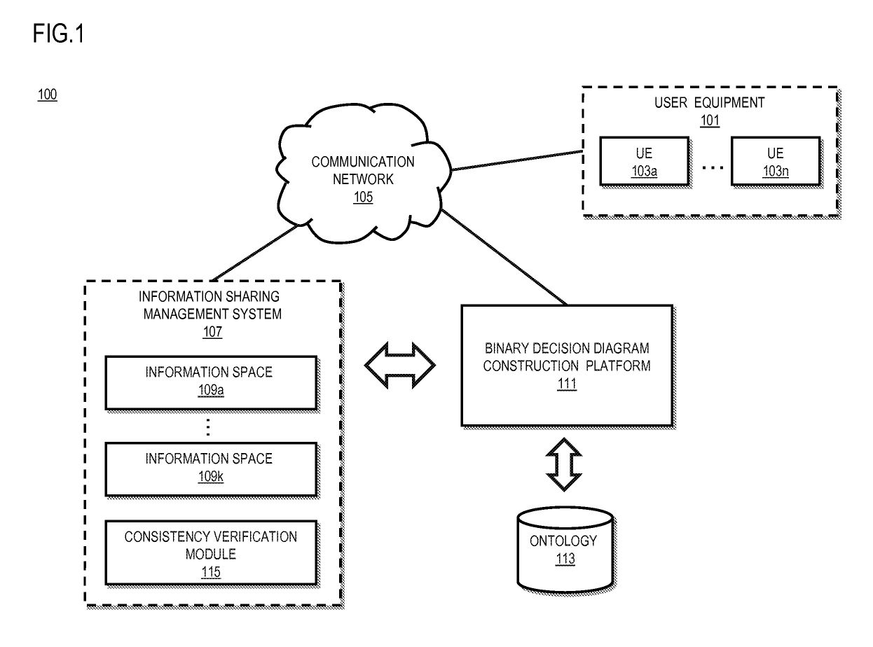

FIG. 1 is a diagram of a system capable of verifying information consistency in distributed information spaces, according to one embodiment. In system 100 of FIG. 1, user equipment 101, information sharing management system 107 and a binary decision diagram (BDD) construction platform 111 communicate through a communication network 105. The information sharing management system 107 includes a collection of distributed information spaces 109a-109k. In order to attach meaning to the information content of distributed information spaces within an information sharing management system 107, the information spaces 109a-109k need to have ontologies defined and assigned to them. These ontologies are saved in ontology database 113. The information content of an information space 109a-109k is in a free form RDF graph, which means that aside from the triple structure, RDF itself does not include any mechanism to monitor operations such as adding, deleting or updating triples in the RDF store thus modifying the graph.

As shown in FIG. 1, the system 100 comprises a user equipment (UE) 101 having connectivity to an information sharing management platform 107 via a communication network 105. By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), or any other suitable packet-switched network, such as a commercially owned, proprietary packet-switched network, e.g., a proprietary cable or fiber-optic network. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, mobile ad-hoc network (MANET), and the like.

The UE 101 is any type of mobile terminal, fixed terminal, or portable terminal including a mobile handset, station, unit, device, multimedia tablet, Internet node, communicator, desktop computer, laptop computer, Personal Digital Assistants (PDAs), or any combination thereof. It is also contemplated that the UE 101 can support any type of interface to the user (such as “wearable” circuitry, etc.).

By way of example, the system 100 is applied to freely formed resource description framework or RDF graphs generated by ontology based information sharing management system 107 over the semantic web. In one embodiment, RDF graphs represent decision diagrams and describe resources with classes, properties, and values. Sets of properties are defined within RDF vocabularies (or Schemas). A node/resource is any object which can be pointed to by a uniform resource identifier (URI), properties are attributes of the node, and values can be either atomic values for the attribute, or other nodes. RDF Schema provides a framework to describe application-specific classes and properties. Classes in RDF Schema are like classes in object oriented programming languages. This allows resources to be defined as instances of classes, and subclasses of classes. The RDF graphs are represented or encoded in decision diagrams which describe the properties and relations of different classes. For example, information about a particular web page (a node), includes the property “Author”. The value for the Author property could be either a string giving the name of the author, or a link to a resource describing the author. One typical example of an rdfs:Class is foaf Person in the Friend of a Friend (FOAF) vocabulary. An instance of foaf:Person is a resource linked to the class using an rdf:type predicate, such as in the following formal expression “John rdf:type foaf:Person” of the natural language sentence.

Each RDF-graph includes a set of unique triples in a form of subject, predicate, and object, which allow expressing graphs. For example, in this piece of information “Jenna is Matti's friend,” the subject may be Jenna, the predicate may be friend, and the object may be Matti. The simplest RDF-graph is a single triple. Any node or entity can store unconnected graphs. As later explained in more detail, the approach described herein can be adapted in a information space that includes the semantic web and has distributed nodes and entities that communicate RDF-graphs (e.g., via a blackboard or a shared memory).

The information space is interoperable over different information domains, different service platforms, and different devices and equipments. For example, the information space accommodates transmission control protocol/Internet protocol (TCP/IP), Unified Protocol (UniPro) created by the Mobile Industry Processor Interface (MIPI) Alliance, Bluetooth protocol Radio Frequency Communication (RFCOMM), IPv6 over Low power Wireless Personal Area Networks (6LoWPAN), etc. The information space also covers technologies used for discovering and using services, such as Bluetooth/human interface device (HID) services, web services, services certified by the Digital Living Network Alliance (DLNA), the Network on Terminal Architecture (NoTA). In addition, the information space constitutes an infrastructure that enables scalable producer-consumer transactions for information, and supports multiparts, multidevices and multivendors (M3), via a common representation of a set of concepts within a domain and the relationships between those concepts, i.e. ontologies. The information space as a logical architecture has no dependencies on any network architecture but it can be implemented on top of practically any connectivity solution. Since there is no specific service level architecture, the information space has no limitation in physical distance or transport.

The information space allows cross domain searches and provides a uniform, use case independent service application programming interface (API) for sharing information. As an example, the information space allows a mobile platform to access contextual information in, e.g., a car, home, office, football stadium, etc., in a uniform way and to improve the user experience, without compromising real-time requirements of the embedded system. The information space uses an ontology governance process as the alternative to using case-specific service API standardization. The ontology governance process agrees and adopts new vocabularies using Resource Description framework (RDF) and RDFS (RDF schema). When RDFS is not sufficient for defining and instantiating the ontologies, web ontology language (OWL) or the like is used.

In FIG. 1 the binary decision diagram construction platform 111 generates an AUGBDD graph for each RDF graph from an information space 109a-109k by using the ontology defined in the ontology database 113. The constructed AUGBDD graphs are saved in the ontology database 113, a separate storage dedicated to AUGBDDs or in any other storage media provided in the system. From the constructed AUGBDD, the system 100 obtains a possible solution to the logical formula the AUGBDD represents by traversing the AUGBDD. This can be done in polynomial time (i.e., the running time is upper bounded by a polynomial in the size of the input for the algorithm). The problem of finding the best variable ordering is NP-hard (NP stands for Nondeterministic Polynomial time), i.e., inherently difficult to provide algorithms that are efficient for both general and specific computations. Since the problem of finding a satisfying assignment to variables in a logical formula is known to be NP complete (the class of NP-complete problems contains the most “difficult” problems in NP), the construction of a BDD is difficult. However, in practice BDDs have proved to be a very efficient way of encoding and operating on large sets, although it may be challenging to find a satisfying assignment of variables in a logical formula to construct a BDD.

In an RDF graph of information, properties that connect classes of objects may be augmented with cardinality information, which places constraints on the types and number of class instances that a property may connect. For instance, the ontology for class PERSON may place a constraint on the domains of both properties NAME and ID. That is the domain of both properties NAME and ID must be from class type PERSON. Additionally, constraints can be added on the range of properties, for example that the range of ID is a number (a data value) and range of name is another class such as FullName.

For setting cardinalities, the number of properties associated with a class instance can be restricted. In the Web Ontology Language (OWL) which is one of the standards for representing information spaces, the cardinalities can be expressed by owl:maxCardinality, owl:minCardinality or owl:Cardinality which assign a lower bound an upper bound and a value to the cardinality respectively. However, it can also be stated that a property can have only one value for a given instance, which is expressed as (owl:FunctionalProperty) in OWL. For example, an instance of class PERSON can have only one property from type ID. Furthermore, a constraint may be imposed that a property value must uniquely identify the instance (owl:InverseFunctionalProperty). By these means it is possible to say that the ID property can only have one value and also that it uniquely identifies a PERSON. It is noted that if no specific constraints are added, all cardinalities will be allowed. In the above example no constraints have been applied on the NAME attribute, as a result an instance of class PERSON may have several unique names associated with it by means of the NAME attribute.

According to one embodiment, a user of user equipment 103a-103n in FIG. 1 generates a request for adding, removing or updating information in an information space 109a-109k from the information sharing management system 107 and sends the request to the information sharing management system 107 through the communication network 105. The information sharing management system 107 verifies user authorization for information update and if the user is authorized, allows access to the information to the requesting user equipment. Access to the information can be granted to a user equipment 103a-103n using the “projection” operation which is a formal operation defined on information spaces. The “projection” operation creates a copy of the requested RDF graph of information to be sent to the user equipment. An interface (not shown) converts the RDF graph of the requested information into a readable form for the user and sends the information to the user equipment via the communication network 105. Upon accessing the information through a communication network 105 for example on a display unit, the user of the user equipment 103a-103n enters desired updates using an input device (e.g., a key board). The information sharing management system 107 receives the updates and the interface converts the received information back into RDF graph form. The RDF graph is then saved in a temporary storage (not shown) while the information sharing management system 107 sends a request to the binary decision diagram construction platform 111 asking for consistency constraints on the RDF graph. Since the consistency constraints involve the types of objects (nodes) in the RDF graph and the cardinality of properties (arcs) connecting the nodes, the information sharing management system 107 may send names of classes of objects and property names along with the request to the binary decision diagram construction platform 111 or use other methods for sharing the information about the RDF graph needed for creation of the binary decision diagram construction platform 111. The binary decision diagram construction platform 111 receives the request and related information and retrieves the ontology related to the specific RDF graph from the ontology database 113. The ontologies may be identified by class names, property names, or a combination of several different identifiers. The binary decision diagram construction platform 111 generates an AUGBDD consisting of consistency constraints based on the retrieved ontology and sends the AUGBDD back to the information sharing management system 107. The information sharing management system 107 forwards the received AUGBDD to the consistency verification module 115 and the consistency verification module 115 then compares the AUGBDD with the contents of the RDF graph stored in temporary storage. If the content of the RDF graph matches with the AUGBDD, an approval is being sent by the consistency verification module 115 to the information sharing management system 107 and the information sharing management system 107 initiates the process for replacing the existing RDF graph of information with the updated RDF graph. The replacement process is carried out using “injection” operation, another formal operation of information spaces. Otherwise, if the updated RDF graph violates any of the rules identified in the ontology the consistency verification module 115 issues a warning to the information sharing management system 107 identifying the violations. The information sharing management system 107 can forward the warning to the user equipment that had initiated the update for the review and correction. For example, if a user is attempting to assign an ID number to a person A while person A already has an ID number assigned and the ontology rule states that a person can have only one ID number, user's attempt to assign a new ID number to person A fails and the user will receive a message stating that: “Person A already has an ID number”. However, if the ontology allows multiple ID numbers, the update process will end successfully and the user input is applied on the RDF graph representing information about person A. This approach enables an information sharing management system 107 that is equipped with a consistency verification module 115 but lacks access to the ontology database 113, to check information consistency without having to send the information content over the network 105. In this case the information sharing management system 107 can send a request to a remote binary decision diagram construction platform 111 and have the remote binary decision diagram construction platform 111 generates the AUGBDD based on the ontology 113. The binary decision diagram construction platform 111 can then forward the generated AUGBDD to the information sharing management system 107 and the locally available consistency verification module 115 can execute the comparison between the information graph whose consistency needs to be checked with the received AUGBDD.

By way of example, the UE 101 and information sharing management system 107 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

The system 100 as described can be used in a semantic web, or in An information space architecture to be available in all locations to all nodes and entities.

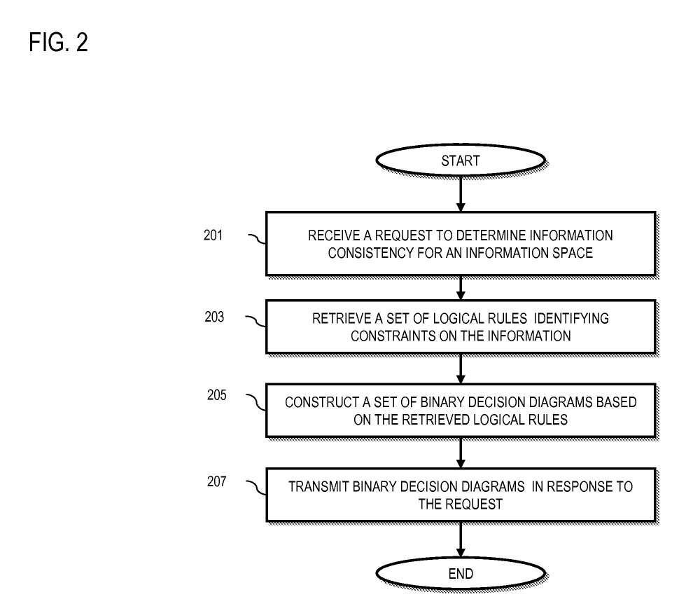

FIG. 2 is a flowchart of a process for constructing binary decision diagrams, according to one embodiment. As seen in FIG. 2 in step 201 the binary decision diagram construction platform 111 receive a request from information sharing management system 107 for constructing a binary decision diagram for an information space 109a-109k. The request may include a certain part of an RDF graph from an information space that needs to be verified, or a link to the RDF graph. In step 203 the binary decision diagram construction platform 111 retrieves rules and constraints defined on the RDF graph by accessing the ontology database 113. The binary decision diagram construction platform 111 may search the content of ontology database 113 by class type, class name, properties connecting classes, class instances or any other search methods available. In step 205 the binary decision diagram construction platform 111 generates an augmented binary decision diagram (AUGBDD) using the retrieved rules.

It is assumed that a RDF graph contains the type information of its subgraphs. This is typically represented by an rdf:type arc in the graph. The augmentation is essentially a constraint for the size of the set described by the BDD that has been embedded in the AUGBDD. An AUGBDD is constructed based on the rules identified in a given ontology and the constructed AUGBDD is applied to the RDF graph to check whether the graph complies with the rules identified in the ontology. One of such rules is that type of the range and the domain of the instances that have a property between them should conform to the rules given in the ontology. For example, if the ontology includes a rule stating, “Property AGE maps an instance of class PERSON into an instance of class INTEGER”, every arc of the RDF graph from type AGE that connects two nodes, needs to be checked such that the starting node is an instance from class PERSON and the ending node is from class INTEGER. If an AGE arc is found in the RDF graph that connects an instance of class PERSON to an instance of class NAME, the property will be marked erroneous and will be reported for correction.

Another consistency issue is cardinality which may arise when the number of class instances connected by a property does not conform to the number identified in the given ontology. In the above example for AGE property, it can be identified in the ontology that AGE is a unique property for every instance of class PERSON meaning that every PERSON can be connected only to one instance of class AGE through an AGE arc. In other words, at most one arc from type AGE can start from any instances of class PERSON. Therefore, if an AGE arc is found in the RDF graph that connects an instance of class PERSON to more than one instances of class INTEGER, the property will be marked erroneous and will be reported for correction.

The AUGBDDs are constructed based on the rules similar to given rules in the above examples. The constructed AUGBDDs can be sent over to a remote system where they can be used locally to check the consistency of local information stores. This allows checking for ontology conformance without direct access to the ontology description.

The AUGBDDs can be constructed for various kinds of ontology consistency checks other than type and cardinality constraints as well. Furthermore, the constructed AUGBDDs can be resolved into queries independently of the ontology, but their expected use is a combination with the information store that has been converted to a BDD, allowing verification of information consistency to be made effectively by utilizing BDD operations. In the first case the BDDs form an effective way of transmitting the ontology consistency information and in the second case also an efficient way of verifying information consistency with respect to an ontology, without transmitting the complete ontology itself

The addition to a BDD for constructing an AUGBDD with cardinality constraints is the addition of cardinality constraints to the sets of the BDDs and sending the constraints alongside the BDD. Expected use of AUGBDD is that given an AUGBDD, the embedded BDD is operated on the local information store to form another resulting BDD. The number of items in set represented by BDD can be efficiently computed from BDDs and this number can be compared to the cardinality constraint.

The consistency check described above is to be used for enforcing consistency of some critical piece of information by a central authority; for example OVI® service mandating consistency of remote clients by sending out AUGBDDs to the clients. An alternative to OVI® can be a local hub such as a car or a residence. The consistency check can also be used for filtering information to be submitted to remote clients so that clients can expose their own notion of consistency (or the information they can understand) by sending AUGBDDs to centralized store.

In step 207 the binary decision diagram construction platform 111 transmits the constructed AUGBDD to the information sharing management system 107 to be used for verifying consistency of the information space.

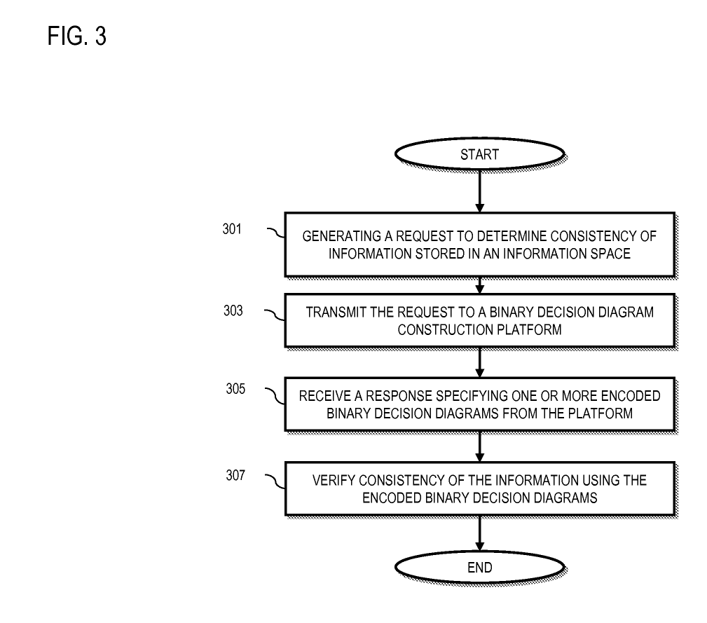

FIG. 3 is a flowchart of a general process for verifying information consistency in information spaces, according to one embodiment. In step 301 the information sharing management system 107 generates a request for consistency determination for an information space which is in form of a graph of information such as an RDF graph. The request may include information about properties (arcs) of the information graph. In step 303 the information sharing management system 107 transmit the request to the binary decision diagram platform 111 for binary decision diagrams to be constructed for the properties of the information graph. In step 305 the information sharing management system 107 receives a set of binary decision diagrams each of which representing the constraints defined in ontology database 113 for one of the properties of the information graph. In step 307 the consistency verification module 115 uses the binary decision diagrams which represent constraints for each property in the information graph and determine whether the arcs in the graph comply with the constraints.

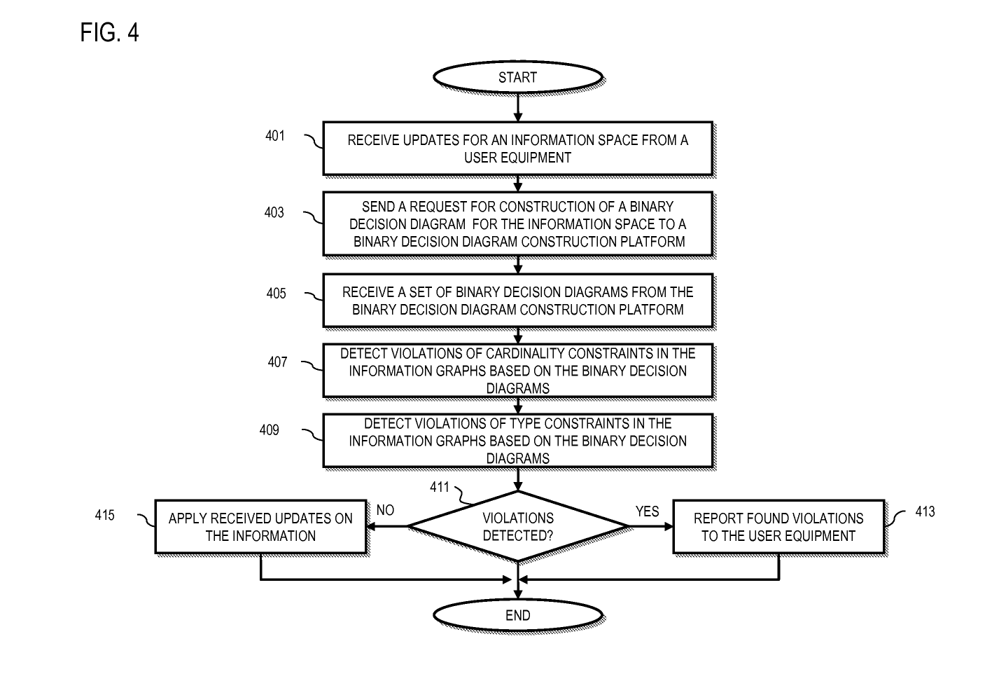

FIG. 4 is a flowchart of an example application for information consistency verification of information spaces, according to one embodiment. In this example, it is assumed that a user is trying to update the information in an information space using a user equipment 103a-103n. For instance a user may want to change a friend's mailing address information. In step 401 of FIG. 4 the information sharing management system 107 receives an update request for an information space 109a-109k from the user equipment 103a-103n. The update request can be encoded by a combination of information space operators such as “split”, “merge”, “projection” and “injection”. For this example, the user equipment generates a “projection” request to retrieve the existing address information from the information space and displays the retrieved information on the equipment monitor for the user to review and apply desired changes. Once user is satisfied with the updates and for example presses an “update” button on an input device, the user equipment generates an “injection” request to replace the existing information in the information space with the updated information.

The information sharing management system 107 verifies the consistency of new information before allowing the information to be inserted in the information space. In step 403 the information sharing management system 107 sends a request to the binary decision diagram construction platform 111 for a set of binary decision diagrams to be constructed for the information space that is being updated, as described in FIG. 2. In step 405 the information sharing management system 107 receives the set of binary decision diagrams generated by the binary decision diagram construction platform 111.

Information consistency verification can be divided into at least two main functions: detection of violations of cardinality constraints for properties with respect to a given ontology; and detection of violations of types of instances connected by a property with respect to a given ontology. For this specific example, the binary decision diagram may include rules representing type constraints such as: property “mailing address” will connect a node from type PERSON to a node from type ADDRESS, assuming that types PERSON and ADDRESS has been previously defined and type ADDRESS is a union of alphabet characters A-Z and digits 0-9. The binary decision diagram may also contain rules representing cardinality constrains such as: for every instance of type PERSON, there can exist at least one and at most two address properties.

In step 407, the consistency verification module 115 compares the updates received from the user with the cardinality information in the binary decision diagrams. Assuming that the updates include user's attempt to add an address for a friend who already has one address property assigned to. According to the cardinality rule above a PERSON may have two mailing addresses and therefore adding the second address is not violating the cardinality constraint.

In step 409, the consistency verification module 115 compares the updates received from the user with the type information in the binary decision diagrams. Assuming that the address that the user is trying to insert for the friend has been typed with pound sign (#) for unit number. According to the type rule and the definition of type ADDRESS above, a mailing address may not include a pound sign (#) and therefore the new address violates the type constraint.

In step 411 the information sharing management system 107 checks whether the consistency verification module 115 has detected any consistency violations. If violations have been detected, in step 413 the information sharing management platform 107 reports detected violations to the user for correction. Otherwise, in step 415 the information sharing management system 107 applies the updates on the information graph. In the example, a type violation was detected. Therefore in step 413 a violation report is sent to the user equipment. Assuming that the user updates the address and removes the pound sign (#) and resends the update request, this time no violations are found and in step 415 the information sharing management system 107 updates the information space using the “injection” operation to insert the second address for the PERSON.

In some arrangements the consistency verification module 115 can be locally situated in the physical proximity from the information space while there is no local access to the logical rules (ontology) of the information. In this case having the binary decision diagrams generated and sent over the network enables the consistency verification module to verify the consistency of information locally without having to send the information to a remote site via the communication network where the ontology can be accessed. Even though the set of binary decision diagrams may be sent over the network, the volume of the data for binary decision diagrams is much lower compared to the volume of information stored in the information space. Also, the process is made more efficient.

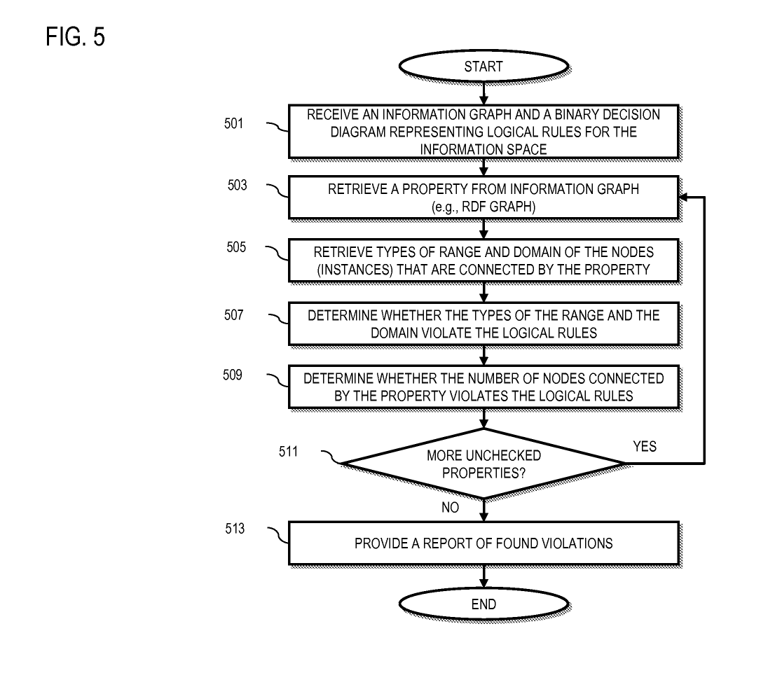

FIG. 5 is a flowchart of the detailed process for information consistency verification of information spaces, according to one embodiment. In step 501 the information sharing management system 107 receives a BDD constructed by the binary decision diagram construction platform 111 from the platform and retrieves the information graph that the BDD was constructed for from the information spaces. In step 503 the consistency verification module 115 retrieved one of the properties (arcs) from the information graph. A property connects two nodes of the information graph as its domain and range. For example, the property can be a HIGHEST_DEGREE property that connects a PERSON to the highest educational degree they have achieved (e.g., B.S., M.S., Ph.D, etc.). In step 505 types of the domain and range for the property is retrieved from the BDD. Assuming that type of domain PERSON is defined as a combination of alphabet characters A-Z, and type of range DEGREES is the set: {BS,MS,BA,MA,MBA,PhD,MD}. In step 507 the consistency verification module 115 compares the value of domain and range for property HIGHEST_DEGREE with the given types. If any violations are detected (PERSON includes a character other than A-Z or DEGREES has a value that is not given in the set above) the property is marked as non-conforming with type constraint from ontology.

In one embodiment the verification process may end as soon as a violation is detected. However, the process can continue for any other existing violations to be detected and reported for correction. In this example, the process continues in step 509 where the cardinality or the number of nodes connected by the property is verified. The HIGHEST_DEGREE property can be a many to one property meaning that more than one instances of class PERSON may share the same highest degree while each instance cannot have more than one highest degree. In step 509 the consistency verification module 115 determines whether the number of instances from class DEGREES connected to every instance of class PERSON is at most one. If there are more than one instances of DEGREES for a PERSON a cardinality violation will be detected and the property is marked as non-conforming with cardinality constraint from ontology.

In step 511 the consistency verification module checks whether there are more properties to be verified and if that is the case the process will be repeated for other properties. At the end when there are no more properties left to be verified, in step 513 the consistency verification module 115 transmits the consistency verification report to the information sharing management system 107 for further action. The report may include the non-conforming properties and the type of violations.

Using AUGBDDs for checking information consistency has several advantages such as: AUGBDDs represent constraints according to an ontology, therefore as long as the components of the system all have access to the constraints set up in the ontology, it is possible to check consistency of local information and there will be no need for sending the information to a centralized consistency checking platform. This means that there is no need to communicate “payload” or content information for consistency checking and this will prevent high volumes of information from being sent over the communication network and will reduce network traffic significantly. Furthermore, since AUGBDDs can be applied for verifying information consistency in RDF graphs, not only information spaces, but any field of technology that uses RDF graphs for information representation such as various web applications can benefit from using AUGBDDs for checking the consistency of the information they handle.

In one embodiment, intended use of submitting AUGBDDs from a centralized store (such as OVI®) to distributed clients (such as M3 Smart Spaces) and conversely from clients to server, is as means for providing a client's view of consistency to the server. Thus, if a user has specific constraint requirements for the information, the request can be sent to the server in the form of a binary decision diagram and after decoding the diagram the logical rules can be inserted into the ontology database 113.

In order to better appreciate the described processes and arrangement relating to the augmentation applied on binary decision diagrams, the concept of binary decision diagram is described below.

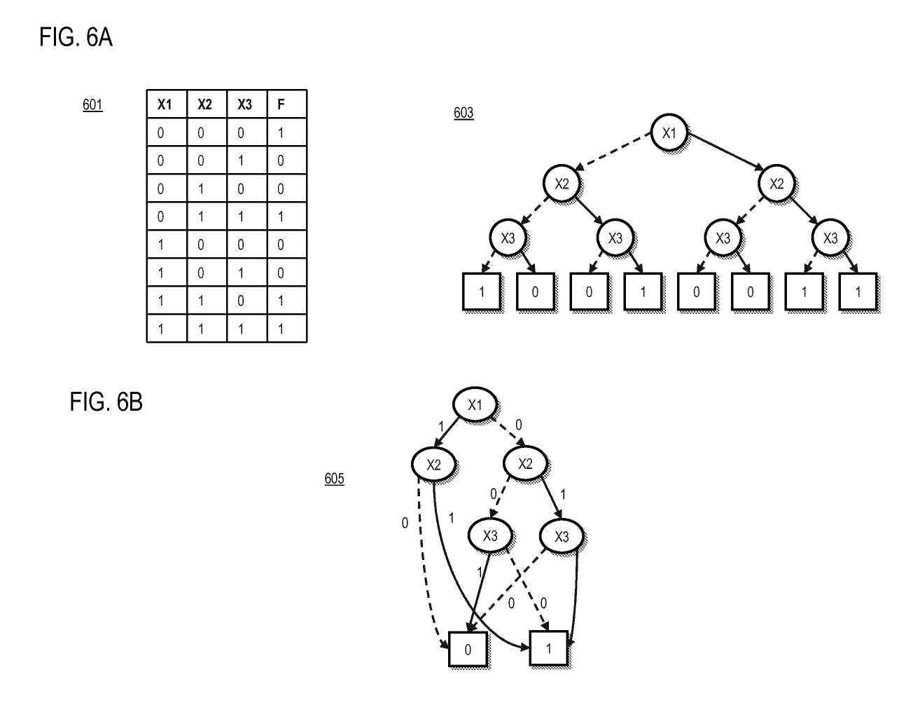

FIG. 6A is a diagram of a binary decision diagram, according to one embodiment. A binary decision diagram (BDD) is essentially a group of Boolean variables in a specific order and a directed acyclic graph over the variables. A depth-first search of the graph yields all possible values of the set described by the BDD. As seen in FIG. 6A, table 601 shows values of a function F based on the values of variables x1, x2 and x3, assuming that various combination of one bit variables x1, x2 and x3 produces F as an answer to a query. The diagram 603 in FIG. 6A is the binary decision diagram for table 601. The function F in FIG. 6A can be represented as:

( [symbol] X₁ [symbol] X₂ [symbol] X₃) [symbol] (X₁ [symbol] X₂ [symbol] X₃ [symbol] ) [symbol] (X₁ [symbol] X₂ [symbol] X₃) [symbol] (X₁ [symbol] X₂ [symbol] X₃)

FIG. 6B is a diagram of a reduced ordered binary decision diagram, according to one embodiment. The success of the system 100 relies on the uniqueness of reduced ordered binary decision diagrams (ROBDD)s. For example, a BDD 605 constructed for given information is unique for a chosen variable order. A ROBDD independently constructed with the same variable order for the same information is always the same over the semantic web or the information space.

ROBDDs represent a set of bits or a relation and they can be constructed from a binary decision tree (representing a set of bits) by means of reduction rules. The constructed BDD is canonical for the set of bits it represents and for the order of its variables.

The basic logical operations AND ( [symbol] ), “OR ( [symbol] ), NOT ( [symbol] ), Equivalence (=), Existential (∃), and Universal (∀) abstractions are defined for BDDs. Therefore, it is possible to construct a new BDD by means of logical operations over BDD(s). From a constructed BDD a possible solution to the logical formula the BDD represents can be drawn by traversing the BDD graph. This can be done in polynomial time (with respect to the number of variables or bits). As the problem of finding a satisfying assignment to variables in a logical formula is known to be NP complete, it is clear that the construction of the BDD may be hard. Also the order of variables will affect the size of the constructed BDD and there are known pathological cases of sets whose BDD representations are always large. However, in practice BDDs have proven to be a very efficient way of encoding and operating on large sets.

Reduced ordered binary decision diagrams (ROBDD) are used as the basis for the consistency verification technology. A Reduced Ordered Binary Decision Diagram (BDD in short) is an efficient representation for a set.

Various ways may be used to convert an information graph (e.g., RDF graph) into the representation of, for example, a BDD or an ROBDD. In one embodiment, general BDD encoding is based on creating a triple (a, b, c) in which pieces of information “a,” “b,” and “c” are represented using three bits per each piece of information. This encoding scheme results in a triple represented, for instance, as (101, 001, 011), that is in turn maintained in a dictionary, e.g., as (a=101, b=001, c=011). In another embodiment, the number of bits used for encoding is calculated based upon the size of an associated letter. In another embodiment, the number of bits used for encoding is a set value such as 32 or 64 bits. BDD encoding can be accomplished by performing logical “OR” (ν) operations with each bit sequence associated with a query result. By way of example, the binary decision diagram construction platform 111 in system 100 constructs a BDD to encode the RDF triple. For instance, the BDD representing triple (a, b, c) (BDD1) gets the following variable assignment for the nine bit variables V1 to V9:

BDD₁=V₁ [symbol] V₂ [symbol] V₃ [symbol] V₄ [symbol] V₅ [symbol] V₆ [symbol] V₇ [symbol] V₈ [symbol] V₉

[symbol]

Each variable is a bit. The satisfying variable assignment to this BDD is precisely the encoding of the above-mentioned triple.

Another triple (b, a, c) or (001,101,011) can also be represented by a BDD (BDD2) by same means as above;

BDD₂= [symbol] V₁ [symbol] V₂ [symbol] V₃ [symbol] V₄ [symbol] V₅ [symbol] V₆ [symbol] V₇ [symbol] V₈ [symbol] V₉

Now it is possible to combine the two BDDs to form a new BDD as follows:

BDD_{NEW}=BDD₁ [symbol] BDD₂ (1)

This can be repeated for all triples in an answer to a query and the resulting BDD will contain all unique triples.

As an example of encoding an augmented binary decision diagram (AUGBDD), the ontology definition for two classes A and B are assumed as follows:
A rdf:type rdfs:Class
B rdf:type rdfs:Class

It is noted that owl:Class can be used for rdfs:Class. The described method and implementation can be applied for all similar means of classification and is not limited to RDF or OWL. The encoding can be added to a dictionary to be used later whenever needed (A=111, B=110, rdf:type=000). If node a in the above example is from class A, then the triple (a, b, c) will be accompanied in RDF store by the triple (a, rdf:type, A) with an encoding (101,000,111) and this will be added to the BDD_{new} as shown in formula (1) above.

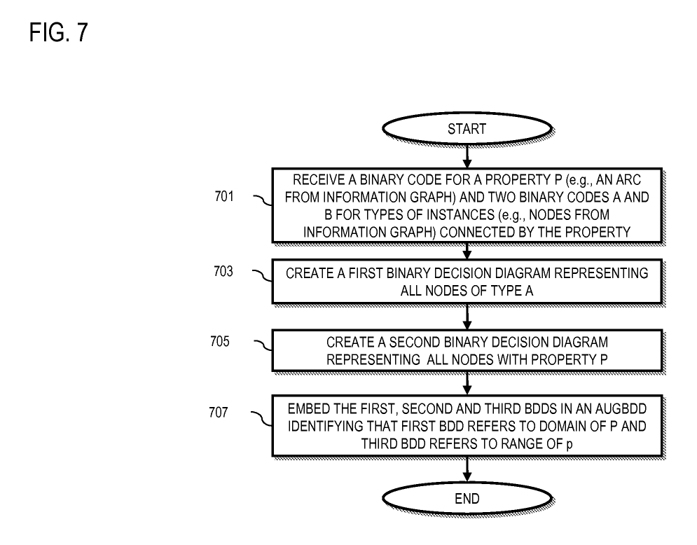

FIG. 7 is a flowchart of a process for constructing an augmented binary decision diagram, according to one embodiment. Assuming that property X exists as a relation between two instances of classes A and B where the logical rules state that domain of X is an instance from class A and the range of X is an instance from class B as follows:
X rdfs:domain A
X rdfs:range B
   On the level of RDF graph, the above assumption states that there is an arc X in the graph that starts from a node (instance) of type A and ends to a node of type B. In order to verify conformance of X (encoded as 010) to the above rules, an AUGBDD is created as follows:

In step 701 of FIG. 7 the binary decision diagram construction platform 111 receives binary codes for property X (010), class A (111) and class B (110). In step 703 the platform creates a binary decision diagram Cl to represent all nodes of type A. These nodes can be represented by the triple (<empty>, rdf:type, A). Since BDDs always have a set of variables (or bits), it is possible to leave the bits corresponding to the first element of the triple undefined (###) and form a BDD as:

C1=(###, 000,111)

In step 705 the platform creates a BDD C2 which represents all nodes that have property X (or graph nodes from which an arc labeled X is leaving). In this BDD both the first element of the triple (domain) and last elements of the triple (range) are left unspecified: (<empty>, X,<empty>)

C2=(###, 010, ###)

In step 707 the BDDs C1 and C2 are embedded in an AUGBDD. In embedding process first C1 and C2 are embedded in a structure A1 which identifies that the first element of every triple represents the domain. Then C1 and C2 are embedded in a structure A2 that identifies that the third element of every triple represents the range.

An ontological container, for instance a class of AUGBDD with two subclasses for domain and range can be defined. The embedding of BDD to AUGBDDs means that the BDD graph is converted to some representation in already known ways. This representation is then augmented with a header (or postfix) which states either ‘domain’ or ‘range’. Later on the header will contain more information about the cardinalities as well.

With the two AUGBDDs A1 and A2 for each property it is possible to check the consistency of a given information space such that the information store is first converted to a BDD, triple by triple as explained above. Typically it is assumed that the information space is already in BDD form and maintained in that form, therefore this step is not necessary for each check.

As an example, assuming insertion of a new triple (b, X b) to graph which already has node b with a assigned type. The consistency of the new triple should be verified with respect to the ontology. The first step for checking the consistency is to check whether the triple conforms to C2 by BDD operation AND. If the triple does not conform a FALSE result will be returned from AND operation meaning that the property X cannot be applied on b as domain and range. In this case the process is terminated. The second step the subject (domain) and the object (range) of the triple are checked against C1 and C3 by BDD operation AND. In order to perform the comparison two BDDs are constructed based on the subject and object of inserted triple and range and domain: (b, rdf type, A) (001, 000, 111) and (b, rdf type, B) (001, 000, 110). In the next step operation AND is applied between the two triples with the BDD of information space. If the result is FALSE, the triple is flagged as inconsistent. During the consistency verification process the triple object of the newly inserted triple needs to be moved to the subject position for its consistency to be checked. The information about this process is also encoded in the AUGBDD header. It is noted that the order of the steps of process can be arbitrary and not specific order is enforced.

As another example, it is assumed that the ontology is augmented so that the cardinality information regarding property X is encoded as follows:
X rdf:type owl:FunctionalProperty

The above definition states that property X is a functional property meaning that an instance of X may exist between instances of its range and domain only so that at most one instance of domain can exist for every instance of the range. In other words in an RDF graph with nodes of types A and B there can be only one arc from type X leaving from each instance of A. There are various ways of placing constraints on numbers of instances a property may apply to; however, use of AUGBDDs as discussed covers all of the methods. In order to verify consistency, the AUGBDD is constructed as described. After the AUGBDD is built the cardinality information are added such that for the triple (a, X b) the BDD (a, X ###) is constructed. By applying AND operation between the BDD and the information space, number of solutions is obtained. This number represents the number of X properties associated with a. The AUGBDD is constructed in a way so that it includes extra information such as a mathematical operator (<=) and a number, which will be 1 in this case. For a functional property X, the number of instances of property X associated with subject a should be less than or equal to 1. This constraint can be added to the AUGBDD. The evaluation of this constraint determines whether an entry is conforming to the ontology. All the standard mathematical comparisons (<,<=,=,!=,>,>=) and any integer number can be used for defining consistency constraints.

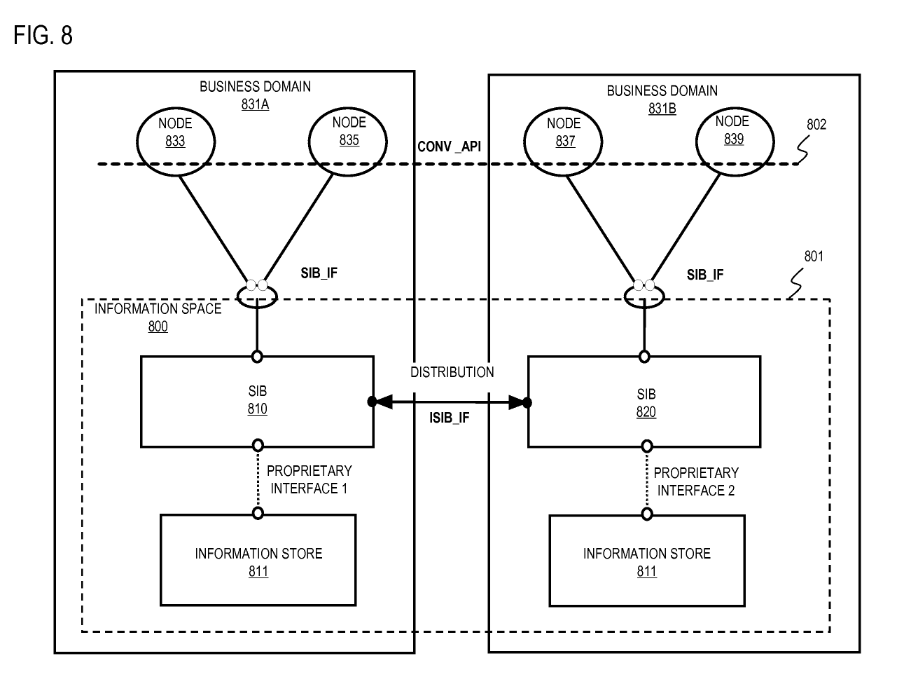

FIG. 8 is a diagram of an implementation for an information space structure, according to one embodiment. Each information space 800 includes information space nodes/objects 833, 835, 837 and 839 and semantic information brokers (SIB) 810, 820 which form the nucleus of the information space 800. Each SIB 810, 820 is an entity performing triple governance in possible co-operation with other SIBs for one information space. A SIB may be a concrete or virtual entity. Each SIB also supports the information space nodes/objects 833, 835, 837 and 839 (e.g., a user, a mobile terminal, or a PC) interacting with other SIBs through information transaction operations. The information space 800 serves private and public entities in different business domains 831A and 831B. By way of example, RDF graphs are used in the information space 800. The triple governance transactions in the information space 800 uses a smart space Access Protocol (SSAP) to, e.g., join, leave, insert, remove, update, query, subscribe, unsubscribe information (e.g., in a unit of a triple). A subscription is a special query that is used to trigger reactions to persistent queries for information. Persistent queries are particular cases of plain queries.

The physical distribution protocol of an information space (i.e., SSAP) allows formation of a information space using multiple SIBs. With transactional operations, a node/object produces/inserts and consumes/queries information in the information space 800. As distributed SIBs belong to the same information space 800, query and subscription operations cover the whole information extent of a information space.

The information space 800 is depicted in the box in a broken line 801 (as the boundary of the information space). There are four devices (nodes) 833, 835, 837 and 839 connected to the information space 800. In the upper part of FIG. 8, a dotted line 802 shows the boundaries of the devices. The devices can be mobile terminals, personal computers, servers, or the like. Each node represents a knowledge processor (KP). KPs are entities contributing to inserting and removing contents as well as querying and subscribing content according to ontology relevant to its defined functionality. A KP needs one or more partner KPs for sharing content and for implementing an agreed semantics for the used ontology. With this implementation structure, the information space serves private and public entities in different business domains A, B using the devices 833, 835, 837 and 839 and KPs running in the business domains A, in order to support the private and public entities to access information services.

In this embodiment, the internal and external indexing tables are embedded in the SSAP protocol at SIB Interfaces (SIB_IF) or Inter SIB Interface (ISIB_IF) upon an “insert” protocol message. To build itself on top of the information space protocol, the system 100 uses ontological constructs, which are, for instance, predefined logical rules. The SIB_IF is an interface between the SIBs and a device, and the ISIB_IF is an interface between two SIBs.

In one embodiment, the approach described herein is implemented at the interfaces SIB_IF and ISIB_IF of the system 100 to verify information consistency. In other embodiments, one or more application programming interfaces (APIs) (e.g., third party APIs) can be used in addition to or instead of SIB_IF and ISIB_IF. The decoding complexity for developing an application is buried below a convenience API (CONV_API) according to FIG. 8. Similarly, the tools for a local (at the node level) information search are provided as a part of a convenience library. However, if a malicious node produces metadata that exponentially increases a graph size (e.g., ROBDD size), the system 100 takes countermeasures such as conditional BDD encoding, and conventional node authentication methods, etc.

Implementations of the described embodiments will result in known interactions between devices or over third party programming APIs, (SIB_IF and ISIB_IF in FIG. 8). Therefore infringements can be easily detected.

The described approach can provides performance gains while still allowing multiple proprietary implementations of information store 811 forming a single information space according to FIG. 8. Therefore, there will be no need to expose the information space infrastructure (e.g., M3) to additional IP or licensing modules.

In the described approach, decoding complexity for application developer can be hidden below the convenience API of FIG. 8. Similarly the tools for local (node level) information search can be provided as part of a convenience library.

The processes described herein for providing verification of information consistency in distributed information spaces may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

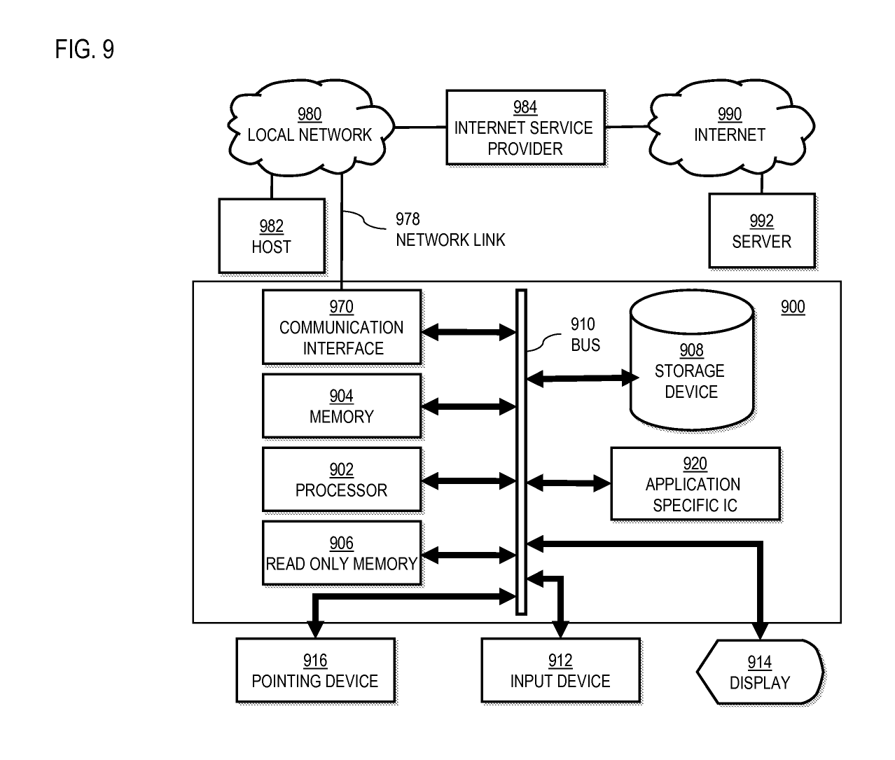

FIG. 9 illustrates a computer system 900 upon which an embodiment of the invention may be implemented. Computer system 900 is programmed (e.g., via computer program code or instructions) to verify information consistency as described herein and includes a communication mechanism such as a bus 910 for passing information between other internal and external components of the computer system 900. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 900, or a portion thereof, constitutes a means for performing one or more steps of information consistency verification.

A bus 910 includes one or more parallel conductors of information so that information is transferred quickly among devices coupled to the bus 910. One or more processors 902 for processing information are coupled with the bus 910.

A processor 902 performs a set of operations on information as specified by computer program code related to information consistency verification. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 910 and placing information on the bus 910. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 902, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 900 also includes a memory 904 coupled to bus 910. The memory 904, such as a random access memory (RAM) or other dynamic storage device, stores information including processor instructions for information consistency verification. Dynamic memory allows information stored therein to be changed by the computer system 900. RAM allows a unit of information stored at a location called a memory address to be stored and retrieved independently of information at neighboring addresses. The memory 904 is also used by the processor 902 to store temporary values during execution of processor instructions. The computer system 900 also includes a read only memory (ROM) 906 or other static storage device coupled to the bus 910 for storing static information, including instructions, that is not changed by the computer system 900. Some memory is composed of volatile storage that loses the information stored thereon when power is lost. Also coupled to bus 910 is a non-volatile (persistent) storage device 908, such as a magnetic disk, optical disk or flash card, for storing information, including instructions, that persists even when the computer system 900 is turned off or otherwise loses power.

Information, including instructions for information consistency verification, is provided to the bus 910 for use by the processor from an external input device 912, such as a keyboard containing alphanumeric keys operated by a human user, or a sensor. A sensor detects conditions in its vicinity and transforms those detections into physical expression compatible with the measurable phenomenon used to represent information in computer system 900. Other external devices coupled to bus 910, used primarily for interacting with humans, include a display device 914, such as a cathode ray tube (CRT) or a liquid crystal display (LCD), or plasma screen or printer for presenting text or images, and a pointing device 916, such as a mouse or a trackball or cursor direction keys, or motion sensor, for controlling a position of a small cursor image presented on the display 914 and issuing commands associated with graphical elements presented on the display 914. In some embodiments, for example, in embodiments in which the computer system 900 performs all functions automatically without human input, one or more of external input device 912, display device 914 and pointing device 916 is omitted.

In the illustrated embodiment, special purpose hardware, such as an application specific integrated circuit (ASIC) 920, is coupled to bus 910. The special purpose hardware is configured to perform operations not performed by processor 902 quickly enough for special purposes. Examples of application specific ICs include graphics accelerator cards for generating images for display 914, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 900 also includes one or more instances of a communications interface 970 coupled to bus 910. Communication interface 970 provides a one-way or two-way communication coupling to a variety of external devices that operate with their own processors, such as printers, scanners and external disks. In general the coupling is with a network link 978 that is connected to a local network 980 to which a variety of external devices with their own processors are connected. For example, communication interface 970 may be a parallel port or a serial port or a universal serial bus (USB) port on a personal computer. In some embodiments, communications interface 970 is an integrated services digital network (ISDN) card or a digital subscriber line (DSL) card or a telephone modem that provides an information communication connection to a corresponding type of telephone line. In some embodiments, a communication interface 970 is a cable modem that converts signals on bus 910 into signals for a communication connection over a coaxial cable or into optical signals for a communication connection over a fiber optic cable. As another example, communications interface 970 may be a local area network (LAN) card to provide a data communication connection to a compatible LAN, such as Ethernet. Wireless links may also be implemented. For wireless links, the communications interface 970 sends or receives or both sends and receives electrical, acoustic or electromagnetic signals, including infrared and optical signals, that carry information streams, such as digital data. For example, in wireless handheld devices, such as mobile telephones like cell phones, the communications interface 970 includes a radio band electromagnetic transmitter and receiver called a radio transceiver. In certain embodiments, the communications interface 970 enables connection to the communication network 105 for providing information consistency verification to the UE 101.

The term computer-readable medium is used herein to refer to any medium that participates in providing information to processor 902, including instructions for execution. Such a medium may take many forms, including, but not limited to, non-volatile media, volatile media and transmission media. Non-volatile media include, for example, optical or magnetic disks, such as storage device 908. Volatile media include, for example, dynamic memory 904. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 920.

Network link 978 typically provides information communication using transmission media through one or more networks to other devices that use or process the information. For example, network link 978 may provide a connection through local network 980 to a host computer 982 or to equipment 984 operated by an Internet Service Provider (ISP). ISP equipment 984 in turn provides data communication services through the public, world-wide packet-switching communication network of networks now commonly referred to as the Internet 990. A computer called a server host 992 connected to the Internet hosts a process that provides a service in response to information received over the Internet. For example, server host 992 hosts a process that provides information representing video data for presentation at display 914.

At least some embodiments of the invention are related to the use of computer system 900 for implementing some or all of the techniques described herein. According to one embodiment of the invention, those techniques are performed by computer system 900 in response to processor 902 executing one or more sequences of one or more processor instructions contained in memory 904. Such instructions, also called computer instructions, software and program code, may be read into memory 904 from another computer-readable medium such as storage device 908 or network link 978. Execution of the sequences of instructions contained in memory 904 causes processor 902 to perform one or more of the method steps described herein. In alternative embodiments, hardware, such as ASIC 920, may be used in place of or in combination with software to implement the invention. Thus, embodiments of the invention are not limited to any specific combination of hardware and software, unless otherwise explicitly stated herein.

The signals transmitted over network link 978 and other networks through communications interface 970, carry information to and from computer system 900. Computer system 900 can send and receive information, including program code, through the networks 980, 990 among others, through network link 978 and communications interface 970. In an example using the Internet 990, a server host 992 transmits program code for a particular application, requested by a message sent from computer 900, through Internet 990, ISP equipment 984, local network 980 and communications interface 970. The received code may be executed by processor 902 as it is received, or may be stored in memory 904 or in storage device 908 or other non-volatile storage for later execution, or both. In this manner, computer system 900 may obtain application program code in the form of signals on a carrier wave.

Various forms of computer readable media may be involved in carrying one or more sequence of instructions or data or both to processor 902 for execution. For example, instructions and data may initially be carried on a magnetic disk of a remote computer such as host 982. The remote computer loads the instructions and data into its dynamic memory and sends the instructions and data over a telephone line using a modem. A modem local to the computer system 900 receives the instructions and data on a telephone line and uses an infra-red transmitter to convert the instructions and data to a signal on an infra-red carrier wave serving as the network link 978. An infrared detector serving as communications interface 970 receives the instructions and data carried in the infrared signal and places information representing the instructions and data onto bus 910. Bus 910 carries the information to memory 904 from which processor 902 retrieves and executes the instructions using some of the data sent with the instructions. The instructions and data received in memory 904 may optionally be stored on storage device 908, either before or after execution by the processor 902.

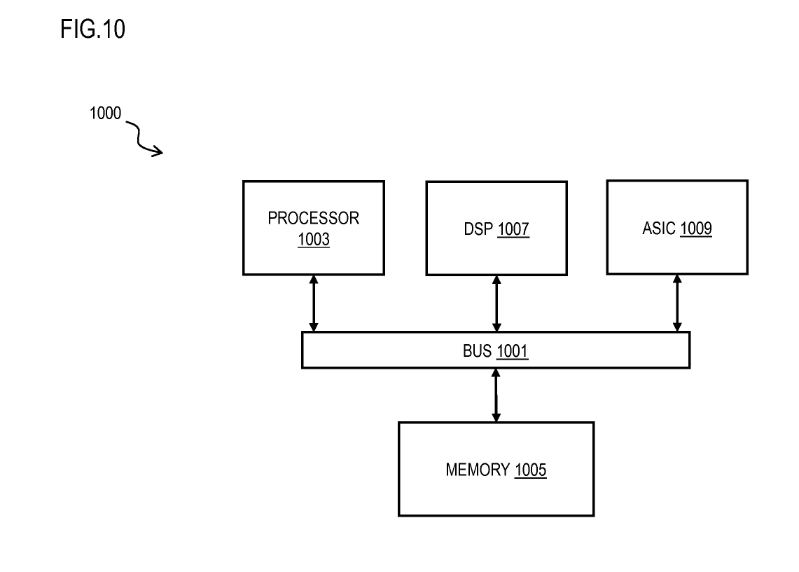

FIG. 10 illustrates a chip set 1000 upon which an embodiment of the invention may be implemented. Chip set 1000 is programmed to verify information consistency as described herein and includes, for instance, the processor and memory components described with respect to FIG. 9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 1000, or a portion thereof, constitutes a means for performing one or more steps of information consistency verification.

In one embodiment, the chip set 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to verify information consistency. The memory 1005 also stores the data associated with or generated by the execution of the inventive steps.

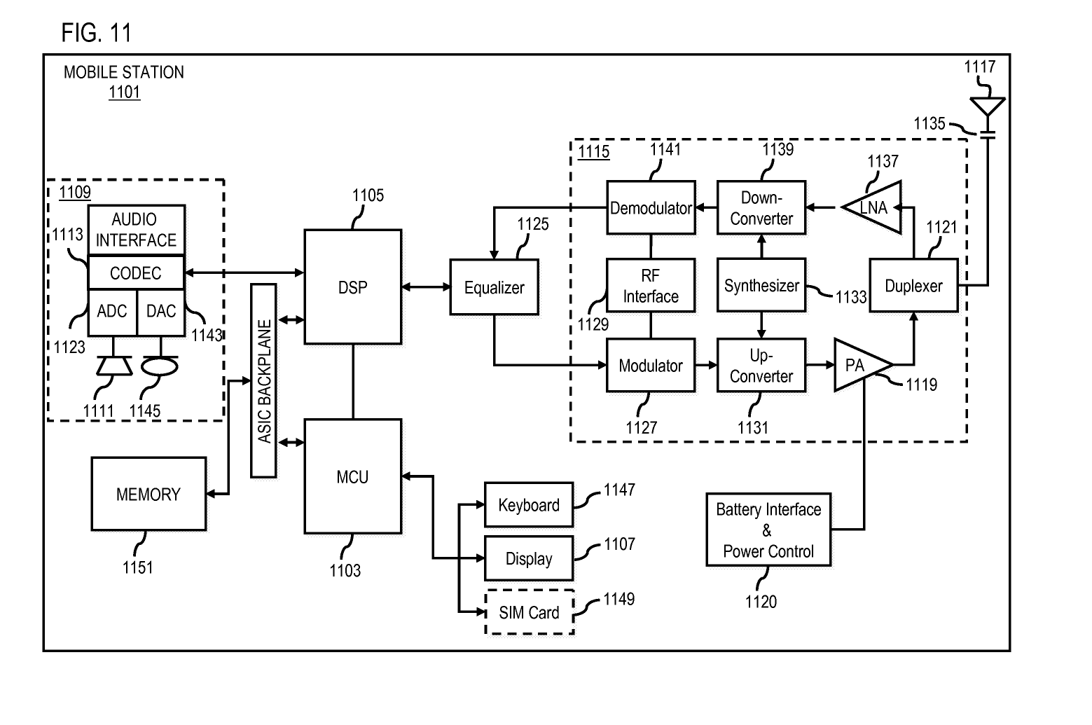

FIG. 11 is a diagram of exemplary components of a mobile terminal (e.g., handset) for communications, which is capable of operating in the system of FIG. 1, according to one embodiment. In some embodiments, mobile terminal 1100, or a portion thereof, constitutes a means for performing one or more steps of information consistency verification. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1103, a Digital Signal Processor (DSP) 1105, and a receiver/transmitter unit including a microphone gain control unit and a speaker gain control unit. A main display unit 1107 provides a display to the user in support of various applications and mobile terminal functions that perform or support the steps of information consistency verification. The display unit 1107 includes display circuitry configured to display at least a portion of a user interface of the mobile terminal (e.g., mobile telephone). Additionally, the display unit 1107 and display circuitry are configured to facilitate user control of at least some functions of the mobile terminal. An audio function circuitry 1109 includes a microphone 1111 and microphone amplifier that amplifies the speech signal output from the microphone 1111. The amplified speech signal output from the microphone 1111 is fed to a coder/decoder (CODEC) 1113.

A radio section 1115 amplifies power and converts frequency in order to communicate with a base station, which is included in a mobile communication system, via antenna 1117. The power amplifier (PA) 1119 and the transmitter/modulation circuitry are operationally responsive to the MCU 1103, with an output from the PA 1119 coupled to the duplexer 1121 or circulator or antenna switch, as known in the art. The PA 1119 also couples to a battery interface and power control unit 1120.

In use, a user of mobile terminal 1101 speaks into the microphone 1111 and his or her voice along with any detected background noise is converted into an analog voltage. The analog voltage is then converted into a digital signal through the Analog to Digital Converter (ADC) 1123. The control unit 1103 routes the digital signal into the DSP 1105 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 1125 for compensation of any frequency-dependent impairments that occur during transmission though the air such as phase and amplitude distortion. After equalizing the bit stream, the modulator 1127 combines the signal with a RF signal generated in the RF interface 1129. The modulator 1127 generates a sine wave by way of frequency or phase modulation. In order to prepare the signal for transmission, an up-converter 1131 combines the sine wave output from the modulator 1127 with another sine wave generated by a synthesizer 1133 to achieve the desired frequency of transmission. The signal is then sent through a PA 1119 to increase the signal to an appropriate power level. In practical systems, the PA 1119 acts as a variable gain amplifier whose gain is controlled by the DSP 1105 from information received from a network base station. The signal is then filtered within the duplexer 1121 and optionally sent to an antenna coupler 1135 to match impedances to provide maximum power transfer. Finally, the signal is transmitted via antenna 1117 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile terminal 1101 are received via antenna 1117 and immediately amplified by a low noise amplifier (LNA) 1137. A down-converter 1139 lowers the carrier frequency while the demodulator 1141 strips away the RF leaving only a digital bit stream. The signal then goes through the equalizer 1125 and is processed by the DSP 1105. A Digital to Analog Converter (DAC) 1143 converts the signal and the resulting output is transmitted to the user through the speaker 1145, all under control of a Main Control Unit (MCU) 1103—which can be implemented as a Central Processing Unit (CPU) (not shown).

The MCU 1103 receives various signals including input signals from the keyboard 1147. The keyboard 1147 and/or the MCU 1103 in combination with other user input components (e.g., the microphone 1111) comprise a user interface circuitry for managing user input. The MCU 1103 runs a user interface software to facilitate user control of at least some functions of the mobile terminal 1101 to verify information consistency. The MCU 1103 also delivers a display command and a switch command to the display 1107 and to the speech output switching controller, respectively. Further, the MCU 1103 exchanges information with the DSP 1105 and can access an optionally incorporated SIM card 1149 and a memory 1151. In addition, the MCU 1103 executes various control functions required of the terminal. The DSP 1105 may, depending upon the implementation, perform any of a variety of conventional digital processing functions on the voice signals. Additionally, DSP 1105 determines the background noise level of the local environment from the signals detected by microphone 1111 and sets the gain of microphone 1111 to a level selected to compensate for the natural tendency of the user of the mobile terminal 1101.

The CODEC 1113 includes the ADC 1123 and DAC 1143. The memory 1151 stores various data including call incoming tone data and is capable of storing other data including music data received via, e.g., the global Internet. The software module could reside in RAM memory, flash memory, registers, or any other form of writable storage medium known in the art. The memory device 1151 may be, but not limited to, a single memory, CD, DVD, ROM, RAM, EEPROM, optical storage, or any other non-volatile storage medium capable of storing digital data.

An optionally incorporated SIM card 1149 carries, for instance, important information, such as the cellular phone number, the carrier supplying service, subscription details, and security information. The SIM card 1149 serves primarily to identify the mobile terminal 1101 on a radio network. The card 1149 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
receiving a request to determine consistency of information stored in an information space;
retrieving one or more logical rule wherein, each of the rules identifies a consistency constraint on the information;
encoding the one or more logical rules into one or more binary decision diagrams each having a constrained set size; and
causing, at least in part, conveyance of the one or more encoded binary decision diagrams in response to the request for determining the consistency.

2. A method of claim 1, wherein the binary decision diagram is augmented with a type constraint.

3. A method of claim 2, wherein violation of the type constraint is determined based on the one or more encoded binary decision diagrams.

4. A method of claim 1, wherein the binary decision diagram is augmented with a cardinality constraint.

5. A method of claim 4, wherein violation of the type constraint is determined based on the one or more encoded binary decision diagrams.

6. An apparatus comprising:
at least one processor; and
at least one memory including computer program code,
the at least one memory and the computer program code configured to, with the at least one processor, cause the apparatus to perform at least the following,
receive a request to determine consistency of information stored in an information space;
retrieve one or more logical rule wherein, each of the rules identifies a consistency constraint on the information;
encode the one or more logical rules into one or more binary decision diagrams each having a constrained set size; and
convey of the one or more encoded binary decision diagrams in response to the request for determining the consistency.

7. An apparatus of claim 6, wherein the binary decision diagram is augmented with type constraints.

8. An apparatus of claim 7, wherein violation of the type constraint is determined based on the one or more encoded binary decision diagrams.

9. An apparatus of claim 6, wherein the binary decision diagram is augmented with a cardinality constraint.

10. An apparatus of claim 9, wherein violation of the type constraint is determined based on the one or more encoded binary decision diagrams.

11. A method comprising:
generating a request to determine consistency of information stored in an information space;
causing, at least in part, transmission of the request to a binary decision diagram construction platform, and receiving a response specifying one or more encoded binary decision diagrams each having a constrained set size, from the platform, wherein the one or more encoded binary decision diagrams are encoded with one or more logical rules, each of the rules identifying a consistency constraint on the information;
verifying consistency of the information using the logical rules of the one or more encoded binary decision diagrams.

12. A method of claim 11, wherein the information space is represented by resource description framework graphs.

13. A method of claim 11, wherein the consistency determination is based on either type, cardinality, or a combination thereof.

14. A method of claim 13, further comprising:
receiving an information graph associated with the binary decision diagram;
retrieving a property from the information graph;
retrieving types of range and domains of nodes associated with the binary decision diagram;
determining whether the types of the range and the domain violate the one or more logical rules; and
determining whether the number of nodes connected by the property violates the one or more logical rules.

15. A method of claim 14, further comprising:
causing, at least in part, reporting of the determined violations.

16. An apparatus comprising:
at least one processor; and
at least one memory including computer program code,
the at least one memory and the computer program code configured to, with the at least one processor, cause the apparatus to perform at least the following,
generate a request to determine consistency of information stored in an information space;
cause, at least in part, transmission of the request to a binary decision diagram construction platform, and receiving a response specifying one or more encoded binary decision diagrams each having a constrained set size, from the platform, wherein the one or more encoded binary decision diagrams are encoded with one or more logical rules, each of the rules identifying a consistency constraint on the information;
verify consistency of the information using the logical rules of the one or more encoded binary decision diagrams.

17. An apparatus of claim 16, wherein the information space is represented by resource description framework graphs.

18. An apparatus of claim 16, wherein the consistency determination is based on either type, cardinality, or a combination thereof.

19. An apparatus of claim 18, wherein the apparatus is further caused to perform:
receive an information graph associated with the binary decision diagram;
retrieve a property from the information graph;
retrieve types of range and domains of nodes associated with the binary decision diagram;
determine whether the types of the range and the domain violate the one or more logical rules; and
determine whether the number of nodes connected by the property violates the one or more logical rules.

20. An apparatus of claim 19, wherein the apparatus is further caused to perform:
report of the determined violations.
